(19) United States
(12) Patent Application Publication
(10) Pub. No.: US 2009/0090040 A1
(43) Pub. Date: Apr. 9, 2009

(54) Balancing Fishing Jig

(76) Inventors: Theresa G. Kite, Tishomingo, OK (US); Charles B. Kite, Tishomingo, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(21) Appl. No.: 12/245,041

(22) Filed: Oct. 3, 2008

Related U.S. Application Data
(60) Provisional application No. 60/997,229, filed on Oct. 3, 2007.

(51) Int. Cl. A01K 85/00; A01K 85/16

(52) U.S. Cl. 43/42.39; 43/43.1

(57) ABSTRACT

The present invention is directed to a balancing fishing jig assembly. The jig has a body portion and a hook portion. The hook portion is embedded in the body portion, and extends therefrom, terminating in a barb. The jig also includes a material which partially covers a shaft of the hook. The body portion includes an eyelet, which is disposed near the center of drag of the jig assembly. When the jig is translated through the water by a fishing line at the eyelet, the body and hook remain substantially vertically disposed regardless of the direction of translation.

### CROSS REFERENCE TO RELATED APPLICATION

This application claims priority to U.S. Provisional Application No. 60/997,229 filed Oct. 3, 2007.

### FIELD OF THE INVENTION

The present invention relates to the field of lures for fishing.

### SUMMARY OF THE INVENTION

The present invention is directed to a jig for use with a fishing line. The jig comprises a center of drag, an elongate body, an elongate hook and an eyelet. The elongate body comprises a weight. The elongate hook comprises a first end and a second end. The first end terminates at a barb end and the second end comprises a shaft. The shaft has a first end. The first end of the shaft is embedded in the body. The eyelet is supported on the body and adapted to attach the jig to the fishing line. The eyelet is located proximate the center of drag, such that the body and elongate hook are substantially vertically disposed as the jig is pulled through water by the fishing line.

In another embodiment, the invention is directed to a jig for use with a fishing line. The jig comprises a first end, a second end, and a middle section comprising an eyelet. The eyelet is disposed on the middle section such that the jig is balanced such that the first end, middle section, and second end are substantially vertically disposed when the eyelet is engaged by the fishing line.

In yet another embodiment, the invention is directed to a jig having a first end and a second end. The jig comprises a means for connecting the jig to a fishing line such that the fishing line translates the jig through water and a means for substantially, vertically disposing the first end and the second end of the jig while the jig is translated through water.

In another embodiment, the invention is directed to a jig for use with a fishing line. The jig comprises a center of drag, a body having a first end and a second end, a hook secured to the first end of the body, and an eyelet. The body comprises a weight. The eyelet is supported proximate the center of drag, and adapted to attach the jig to the fishing line such that as the jig is translated through water, the drag applied to the jig above the center of drag is substantially equivalent to the drag applied to the jig below the center of drag when the first end and the second end are substantially vertically disposed.

### BRIEF DESCRIPTION OF THE DRAWINGS

FIG. 1 is a depiction of a fishing jig in accordance with the present invention.

FIG. 2 is a partially cross-sectional depiction of the fishing jig of FIG. 1.

FIG. 3 is an example force diagram associated with the fishing jig of the present invention.

### DETAILED DESCRIPTION OF THE DRAWINGS

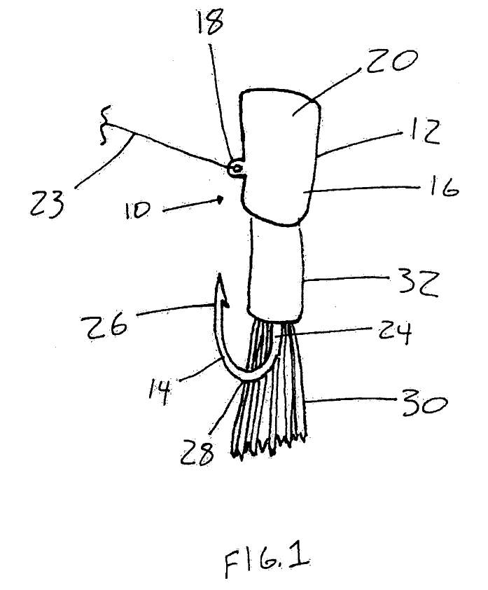

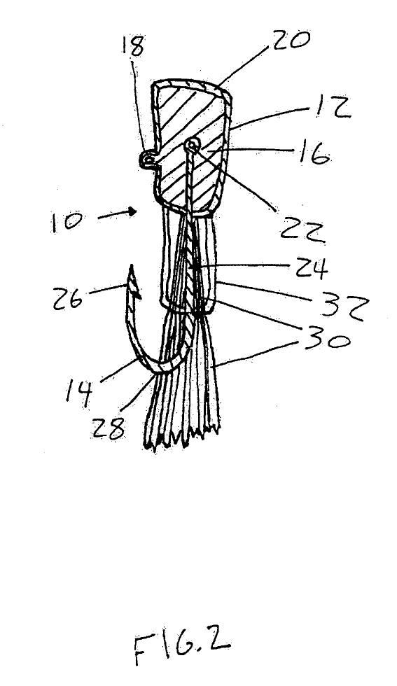

Turning to the drawings in general and FIG. 1 in particular, shown therein is a jig assembly 10 of the present invention. The jig assembly 10 comprises a body 12 and an elongate hook 14. The body 12 comprises a weight 16 and an eyelet 18. The weight 16 is made of a heavy material sufficient to cause the density of the jig assembly 10 as a whole to be greater than that of water. The weight 16 may be made of any heavy material such as lead. In the preferred embodiment of FIG. 1, the weight 16 has a generally rectangular shape which is similar to an elongated cube having eased, slightly rounded edges. Alternatively, the weight 16 may be shaped as an ellipsoid, prism, or other three dimensional shape. The weight is completely covered with an exterior coating 20, as depicted in the cross-sectional depiction of FIG. 2, such as a paint or plastic material. A variety of exterior coatings 20 may be utilized to personalize the jig apparatus 10 for an individual user. The hook 14 is embedded within the weight 16 at a first point 22 of the body 12.

With reference again to FIG. 1, the eyelet 18 is fixed to the weight 16 such that the eyelet 18 protrudes from the weight and extends away in a first direction. The eyelet 18 is preferably made of the same material as the weight 16, but may alternatively be made of different metal, plastic or other composition. The eyelet 18 provides a means for attaching the jig 10 to a fishing line 23.

With reference to FIG. 2, the hook 14 comprises a first end, or shaft portion 24, a curved end 28 and a barb 26. The shaft portion 24 is embedded in the weight 16 at the first point 22 and is made of a substantially rigid material such as a metal. As shown, the shaft portion 24 is substantially straight and extends from the first point 22 to the substantially semi-circularly curved end 28. Preferably, the semi-circularly curved end 28 curves in the first direction such that a plane of the curved end is coplanar with the eyelet 18. The curved end 28 terminates in the barb 26. The barb 26 may comprise any of a multitude of standard fishing barbs which enable the hook to pierce a fish and restrict the fish's ability to loosen itself from the jig assembly 10. Accordingly, the hook 14 may comprise a common fishing hook. In manufacture, the hook 14 may be set in a mold, while the metal material for the weight 16 and eyelet 18 are poured around the hook such that it is embedded and secured at the first point 22.

With continued reference to FIG. 1 the jig assembly 10 preferably comprises a shaft covering material 30. The shaft covering material 30 is attached to the weight 16. As shown in FIG. 1, the shaft covering material 30 comprises feathers. Alternatively, one skilled in the art will appreciate the materials may comprise one or a combination of natural or synthetic feathers, fur, rubber, fabric materials, sponge materials, elastic materials, or others. As shown in FIG. 1, the shaft covering material 30 extends from the weight 16 outward toward the curved end 28 of the hook 14.

The shaft covering materials 30 include a fur or fabric material 32 which is wrapped around the length of the hook shaft so as to encompass the hook shaft and the feathers, thereby securing the feathers in place along the hook 14.

The shaft covering materials 30 may have a variety of colors or textures. These colors may serve a functional purpose, such as the attraction of a certain species of fish or fish at a certain time of day or time of year, or they may serve a personal purpose, such as promotion of a business, university, or sports team.

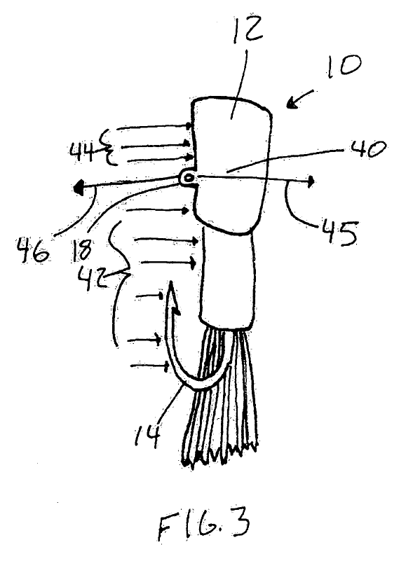

Turning how to FIG. 3, the jig apparatus 10 comprises a center of drag 40. As the jig 10 is translated horizontally with the body 12 and hook 14 substantially vertically disposed, the center of drag 40 comprises the point at which, as viewed in FIG. 3, the lower forces 42 acting to spin the jig counter-clockwise and the upper forces 44 acting to spin the jig clockwise are equivalent.

The eyelet 18 is aligned proximate the center of drag 40. The alignment of the eyelet 18 a allows a resultant drag force 45 of the upper forces 44 and the lower forces 42 to act upon the jig 10 at the same location as a force of translation 46 through the water by the fishing line 23. Thus little or no rotational force acts to spin the jig 10 out of its substantially vertical orientation, allowing the jig assembly to remain in a substantially vertical orientation regardless of the translation force 46 applied as the jig is translated through water. Preferably, the jig 10 is in a substantially vertical orientation regardless of the direction of the translation force 46.

Various modifications in the design and operation of the present invention are contemplated without departing from the spirit of the invention. For example, the jig 10 is scalable and can be applied to a variety of different sized jig 10 and hook 14 assemblies having a variety of lengths. Thus, while the principal preferred construction and modes of operation of the invention have been illustrated and described in what is now considered to represent its best embodiments it should be understood that the invention may be practiced otherwise than as specifically illustrated and described.

What is claimed is:

1. A jig for use with a fishing line, the jig comprising:
a center of drag;
an elongate body comprising a weight;
an elongate hook comprising a first end and a second end, wherein the first end terminates at a barb end and the second end comprises a shaft;
the shaft having a first end,
wherein the first end of the shaft is embedded in the body; and
an eyelet supported on the body adapted to attach the jig to the fishing line;
wherein the eyelet is located proximate the center of drag;
such that the body and elongate hook are substantially vertically disposed as the jig is pulled through water by the fishing line.

2. The jig of claim 1 further comprising at least one shaft covering material.

3. The jig of claim 2 wherein the at least one shaft covering material comprises feathers.

4. The jig of claim 2 wherein the at least one shaft covering material comprises fur.

5. The jig of claim 2 wherein the at least one shaft covering material comprises fabric.

6. The jig of claim 1 wherein the first end and the second end are substantially vertically disposed regardless of the direction of translation.

7. A jig for use with a fishing line, the jig comprising a first end, a second end, and a middle section comprising an eyelet, wherein the eyelet is disposed on the middle section such that the jig is balanced such that the first end, middle section, and second end are substantially vertically disposed when the eyelet is engaged by the fishing line.

8. A jig having a first end and a second end, the jig comprising:
a means for connecting the jig to a fishing line;
such that the fishing line translates the jig through water; and
a means for substantially vertically disposing the first end and the second end of the jig while the jig is translated through water.

9. A jig for use with a fishing line, the jig comprising:
a center of drag;
a body having a first end and a second end, the body comprising a weight;
a hook secured to the first end of the body; and
an eyelet supported proximate the center of drag, the eyelet adapted to attach the jig to the fishing line;
such that as the jig is translated through the water, the drag applied to the jig above the center of drag is substantially equivalent to the drag applied to the jig below the center of drag when the first end and the second end are substantially vertically disposed.

10. The jig of claim 9 wherein the body comprises at least one, shaft covering material.

11. The jig of claim 10 wherein the at least one shaft covering material comprises feathers.

12. The jig of claim 10 wherein the at least one shaft covering material comprises fur.

13. The jig of claim 10 wherein the at least one shaft covering material comprises fabric.

14. The jig of claim 9 wherein a material is wrapped around the length of the hook.

15. The jig of claim 9 wherein the first end and the second end are substantially vertically disposed regardless of the direction of translation.
